(19) United States
(12) Patent Application Publication
(10) Pub. No.: US 2010/0077592 A1
(43) Pub. Date: Apr. 1, 2010

(54) SYSTEM AND METHOD FOR HANGING SOLAR PANELS FROM A HORIZONTAL SUPPORT

(76) Inventor: PETER CASANO, Jackson, MS (US)

Correspondence Address: Patent Jurist, 2225 East Bayshore Road, Suite 200, Palo Alto, CA, 94303, US

(21) Appl. No.: 12/568,848

(22) Filed: Sep. 29, 2009

Related U.S. Application Data
(60) Provisional application No. 61/101,780, filed on Oct. 1, 2008.

(51) Int. Cl. B23P 11/00

(52) U.S. Cl. 29/434

(57) ABSTRACT

A method for hanging solar panels from a horizontal support, in one example embodiment, comprises pivotally coupling one or more solar panels to a rigid support, wherein the one or more of solar panels are free to rotate about the rigid support, the rigid support being substantially horizontal to the ground level, the one or more solar panels having a backside and front side, further comprising a counterweight rigidly attached to the backside, the counterweight tilting the one or more solar panels as to increase exposure of the front side to the sun.

### RELATED APPLICATIONS

This application claims the benefit of the filing date of Provisional Application 61/101,780 filed on Oct. 1, 2008, which is incorporated herein by reference.

### FIELD OF THE INVENTION

The present invention relates to a system and method for deploying solar panels by suspending them from a horizontal support using a hinge that allows a pendulum type motion.

### BACKGROUND OF THE INVENTION

The vast majority of solar panels require to be fixed to their rigid support. Large surface areas of solar panels require building large surface areas of rigid supports. Such installation is expensive to assemble and disassemble and requires extensive altering of the rigid support. Moreover, wind forces need to be considered when one attempts to support large surface areas in a specific orientation.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a process for mounting solar panels comprises pivotally coupling one or more solar panels to a rigid support, wherein the one or more solar panels are free to rotate about the rigid horizontal support, the rigid support being substantially horizontal to the ground level.

In an example, the rigid support is a tension cable comprising an insulated electrical transmission wire. In an example, the one or more solar panels have a backside and front side, further comprising a counterweight rigidly attached to the backside, each tilting the one or more solar panels as to increase exposure of the front side to the sun. In an example, the counterweight comprises a rod having a first end and a second end, wherein the first end is rigidly attached to the backside and the second end is attached to a ball counterbalancing the one or more solar panels.

In an example, the counterweight is substantially planar, the counterweight being attached at one or more points on the backside of the one or more solar panels. In an example, the counterweight has one or more apertures, the apertures permitting air to pass through the counterweight. In an example, the one or more solar panels are mounted such that the horizontal support bears the weight of one or more rows of the one or more solar panels. In an example, a movement dumping connector connects the one or more solar panels, the movement dumping connector-dumping movement of the one or more solar panels.

In an example, an array being comprised of one or more rows and columns of the one or more solar panels is further supported by a rigid vertical pole on each end, arranged in a planar formation, substantially at a right angle to a level-supporting surface. In an example, the array is oriented at an obtuse angle to the level supporting surface. In an example, the one or more solar panels are arranged in clothesline like fashion in such a way as one or more horizontal supports, which support rows of solar panels, are attached at least on each end to one or more rigid T-shaped poles. In an example, the one or more solar panels are attached to a vertical pole, the vertical pole being attached to the level supporting surface.

In an example, the one or more solar panels are mounted on one or more rooftops. In an example, the one or more solar panels coupled to a rigid horizontal support so that the one or more solar panels are free to rotate about the horizontal support. In an example, the horizontal support bears the weight of one or more rows of the one or more horizontal panels. In an example, the process for mounting solar panels further comprising one or more joints attached to the horizontal support as to allow pivoting in additional directions.

In an example, the process for mounting solar panels further comprises one or more movement dumping connectors attached to the horizontal support to allow movement of the solar panels in additional directions. In an example, the process for mounting solar panels further comprises one or more hinges attached to the horizontal support as to allow movement of the solar panels in additional directions. In an example, the process for mounting solar panels further comprises a hinge attached above each joint to the horizontal support.

### BRIEF DESCRIPTION OF DRAWINGS

Example embodiments are illustrated by way of example and not limitation in the figures of the accompanying drawings, in which like references indicate similar elements and in which:

FIG. 1 is a lightweight solar panel coupled to a tensioned cable and electrical transmission wire assembly, in accordance with an example embodiment;

FIG. 2 is a cross section of support cable and electrical transmission wire assembly, in accordance with an example embodiment;

FIG. 3 is a front view of an assembly with a lever with a ball weight, in accordance with an example embodiment;

FIG. 4 is a further front view of an assembly with a lever with a ball weight, in accordance with an example embodiment;

FIG. 5 is a back view of an assembly with a lever with a ball weight, in accordance with an example embodiment;

FIG. 6 is a back view of an assembly with a fin like panel, in accordance with an example embodiment;

FIG. 7 is a plurality of assemblies joined by a movement dumping connector, in accordance with an example embodiment;

FIG. 8 is a close up angle view of the movement dumping connector, in accordance with an example embodiment;

FIG. 9 is an installation of the assembly tensioned between two vertical poles, in accordance with an example embodiment;

FIG. 10 is an installation of the assembly tensioned between two angular poles, in accordance with an example embodiment;

FIG. 11 is an installation of the assembly tensioned between two horizontal poles, in accordance with an example embodiment;

FIG. 12 is an installation of the assembly tensioned between two mounting poles that attach under the eaves of a roof, in accordance with an example embodiment;

FIG. 13 is an deployment of the assembly using a single vertical pivoting pole with a plurality of multiple horizontal supports, in accordance with an example embodiment; and

FIG. 14 is a deployment with a fixed position pivot interposed between the hinge assembly and the solar panel, in accordance with an example embodiment.

### DETAILED DESCRIPTION

Example system and method for hanging solar panels from a horizontal support is described. In the following description, for purposes of explanation, numerous specific details are set forth in order to provide a thorough understanding of example embodiments. It will be evident, however, to one skilled in the art that the present invention may be practiced without these specific details.

In some example embodiments, the system and method for hanging solar panels from a horizontal support provides an inexpensive approach for mass deployment of solar panels. The approach utilizes solar panel designs that are lighter in weight and less fragile than the silicon-based panels.

By hanging these lightweight panels from horizontal supports like tensioned cables, large surface areas of panels can be achieved without having to build large surface areas of rigid supports. One issue that can arise when one attempts to support large surface areas in a specific orientation is that wind forces will need to be considered. The system and method for hanging solar panels, in some example embodiments, addresses this issue by allowing the panels to pivot in the wind like a pendulum thereby reducing their cross sectional area and diffusing the force created by wind. Example systems and methods to dampen and limit the motion created by wind are described below. Additionally, systems and methods to orient the panels relative to the sun are also described below.

An example system and method for hanging solar panels from a horizontal support is described herein. Examples embodiments can utilize a tensioned cable, a horizontal bar, or the edge of a roof eave. The panel backing assembly would swing like a pendulum in the wind. Example embodiments described herein permit the panels to rest at an angle relative to the ground to improve the orientation relative to the sun. Example embodiments described herein permit the panels to be fixed in an orientation other than that of the horizontal support to accommodate preexisting horizontal supports that are not optimally aligned with the sun in the left-right direction. The solar panels can pivot in the wind reducing the structural requirements needed to support panels from wind forces.

FIG. 1 illustrates a lightweight solar panel coupled to a tensioned cable and electrical transmission wire assembly 104, also called the horizontal support, in accordance with an example embodiment. The assembly 104 can be of different width and height depending on the application. A solar panel 102 can be deployed from the horizontal support. As shown in FIG. 1, hinges 106 can attach the solar panel 102 to the tensioned cable and electrical transmission wire assembly 104.

The solar panel 102 can be affixed to a backing material 304 shown below with reference to FIG. 3. The backing material can be weatherproof and rigid but light such as, for example, aluminum or plastic. The assembly 104 can include the backing material 104. The solar panel 102 can hang vertically by the force of gravity and can pivot freely on the horizontal support about the hinges 106 in the wind. In some example embodiments, the assembly 104 can bear the weight of one row of solar panels.

In some example embodiments, the system and method for hanging solar panels permits angling of the solar panel 102 relative to the sun. The solar panel 102 can be of different height or width depending on the specifics of the deployment. The systems and methods for hanging solar panels includes attaching the solar panel 102 to the horizontal support in a way that permits the solar panel 102 to safely pivot in the wind like a pendulum thereby reducing wind forces on the horizontal support despite the large surface area of the assembly 104.

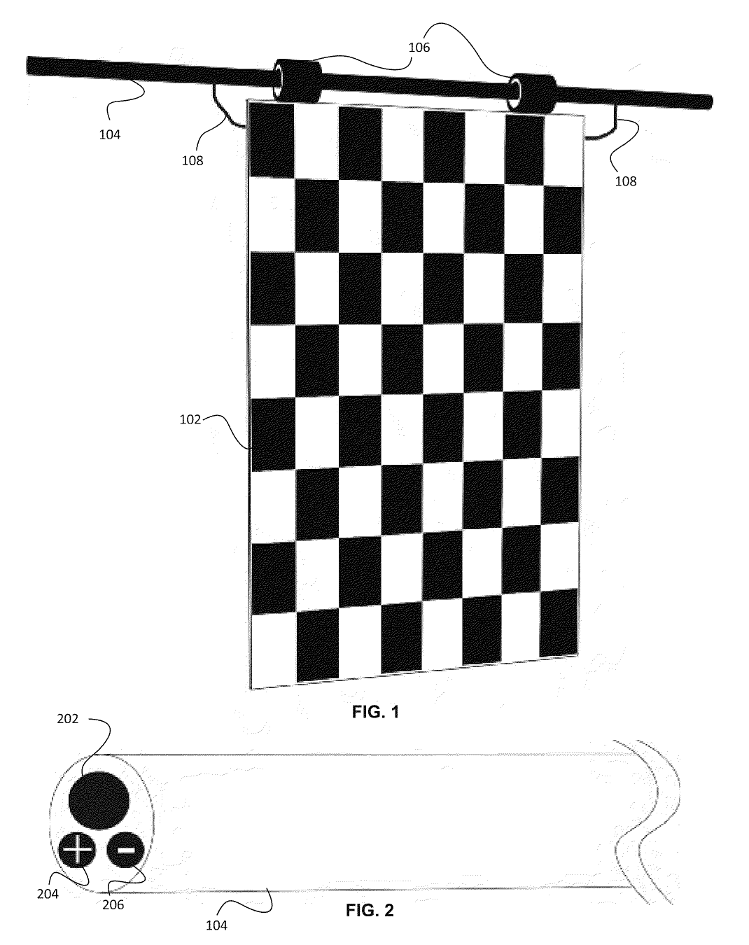

A tensioned cable 202 and transmission wires 204 and 206 are described with reference to FIG. 2. An electrical connection 108 can connect the solar panel 102 to the assembly 104. In some example embodiments, the electrical connection 108 can be integrated into the hinges 106. FIG. 2 is a cross section of support cable and electrical transmission wire assembly 104, in accordance with an example embodiment. As show in FIG. 2, the assembly 104 can include a tensioned support cable 202 and electrical wires 204 and 206. The wires 204 and 206 are responsible for transmitting respective positive and negative electrical charges from the solar panel 102.

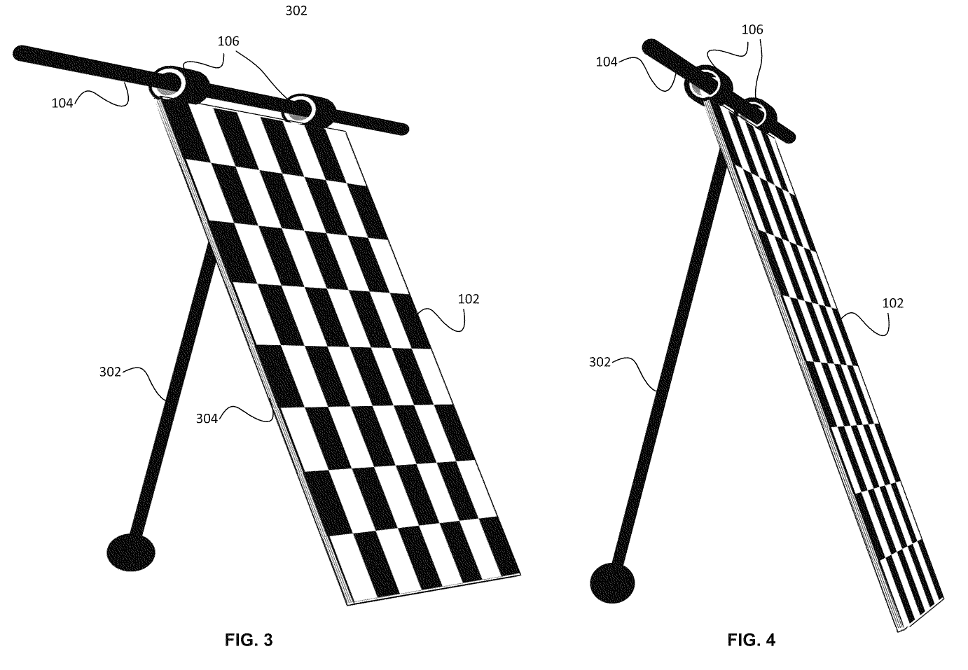

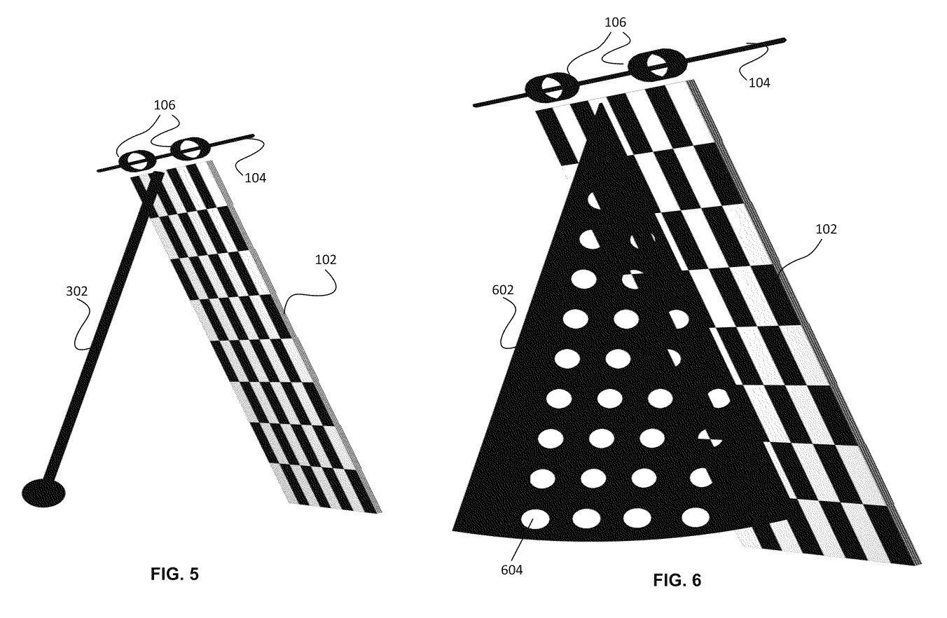

FIG. 3 is a front view of an assembly 104 with a lever 302, in accordance with an example embodiment. The lever 302 includes a ball weight. One of the functions that the support system must consider is the orientation of the solar panel 102 relative to the sun. Optimally sunlight falls on the solar panel 102 in exactly a perpendicular orientation. The solar panel 102 that hangs from the horizontal support can hang vertically and may not provide the most efficient orientation. By including a counterweight that is held away from the panel by the lever 302, on the backside of the assembly 104, the solar panel 102 can be forced to come to rest at a more efficient angle relative to the sun in the up-down direction. This lever 302 can be designed to have minimal cross sectional area to prevent it from significantly adding to the resistance of the wind forces. Thus, lever 302 keeps the solar panel 102 at an angle yet does not appreciably increase wind resistance. FIG. 4 is a further front view of the assembly 104 with the lever 302, in accordance with an example embodiment. FIG. 5 is a back view of an assembly 104 with the lever 302, in accordance with an example embodiment.

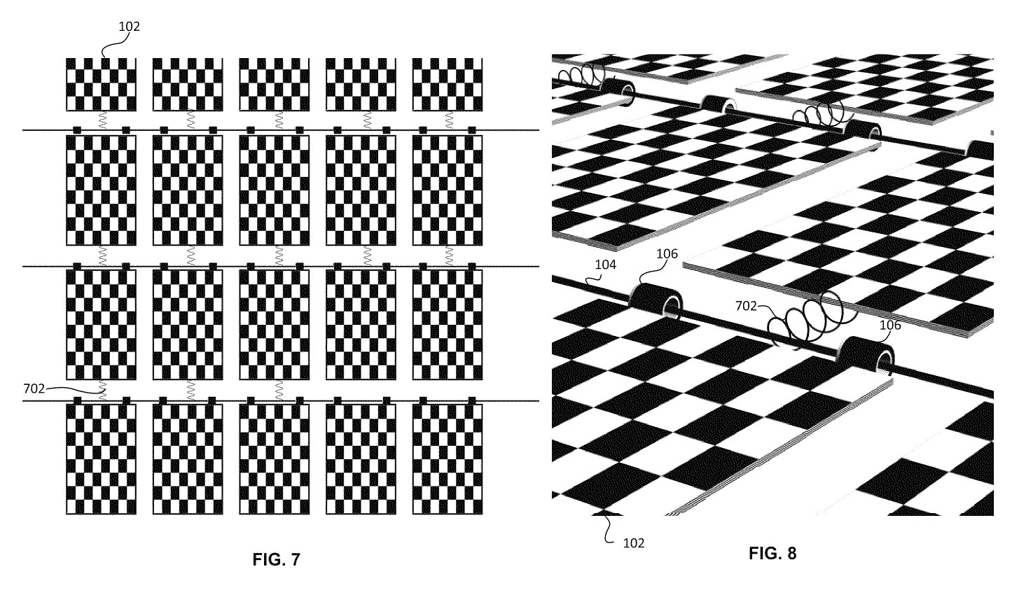

FIG. 6 is a back view of the assembly 104 with a fin-like panel 602, in accordance with an example embodiment. The lever and weight can include numerous configurations. Another possible configuration is the fin-like panel 602 that accomplishes the same goal of reducing the wind resistance. The fin-like panel 602 is a triangular panel with apertures 604 to let the wind through the fin-like panel 602. The fin-like panel 602 can be adjusted to change the angle of the solar panel 102. It will be understood that any configuration that holds a weight at a distance from the panel and at the same time has a limited wind resistance, can serve to angulate the solar panel 102.

FIG. 7 illustrates a plurality of solar panel assemblies joined by a movement dumping connector 702 (“coil”), in accordance with an example embodiment. Each solar panel, shown in checkers, is suspended from a tensioned cable. The “coil” represents the movement dumping connector 702 that joins the mobile lower margin of one solar panel with the cable below it. The movement dumping connector 702 is designed to dampen and limit the movement of the solar panels in the wind. It will be understood that even though the movement dumping connector 702 is shown as a coiled spring-like connector, any other connector designed to dampen and limit the solar panel's movement in the wind, can be used. For example, movement-dumping connector 702 can be made of a wire, string, spring, or any elastic other elastic material. FIG. 8 is a close up angle view of the movement dumping connector 702, in accordance with an example embodiment.

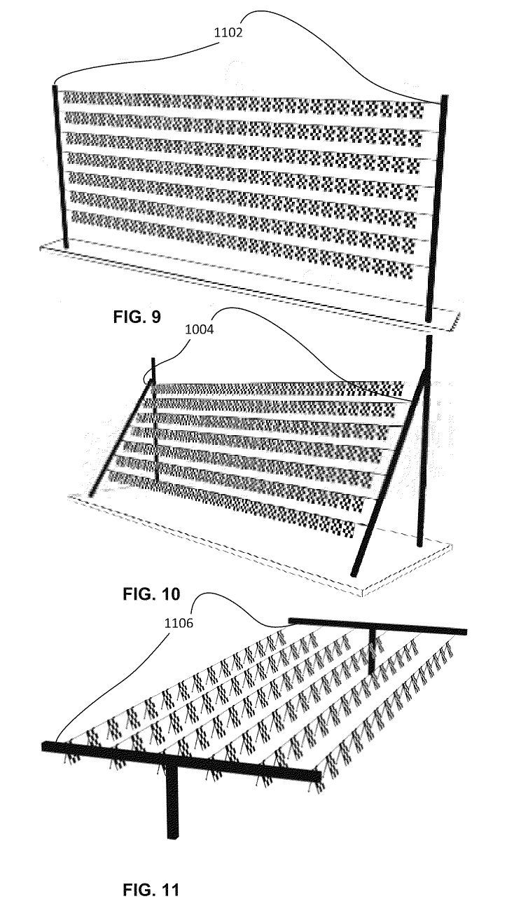

FIG. 9 is an installation of the assembly 104 between two vertical poles, in accordance with an example embodiment. As shown in FIG. 9, 7 rows of solar panels are created by 7 cables that are tensioned between the two poles. It will be understood that any number of solar panels and cables can be used. FIG. 10 is an installation of the assembly tensioned between two angular poles, in accordance with an example embodiment. FIG. 10 illustrates an approach that shows how angulated poles can be used to better arrange and orient the solar panels for maximum sun exposure.

FIG. 11 is an installation of the assembly tensioned between two horizontal poles, in accordance with an example embodiment. The approach illustrated in FIG. 11 has the solar panels hung in a fashion resembling clothes on a clothesline. This approach can permit panels to remain closer to the ground for cosmetic purposes and to reduce exposure to the wind. The system and method for hanging solar panels from a horizontal support can permit various installations of solar panels using the horizontal support system in freestanding solar farms.

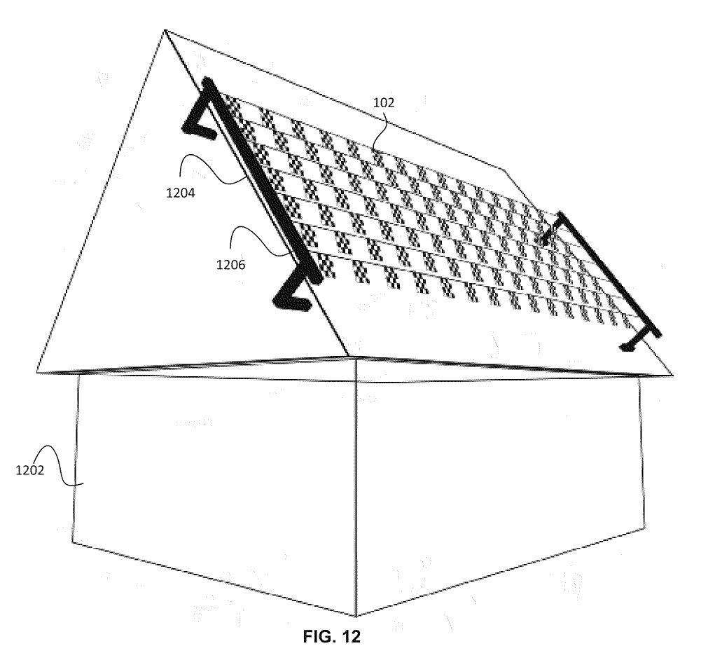

The system and method for hanging solar panels can make possible installation of solar panels using a horizontal support suspension system when retrofitting existing structures. For example, roof mounting can be performed without disturbing the existing roofing material and without the potential to cause roof leaks. In this regard, FIG. 12 is an installation of the assembly 102 tensioned between two mounting poles 1206 that attach under eaves 1204 of the roof, in accordance with an example embodiment. Using this approach, no holes are made in the roof and no modifications are made to the roofing material.

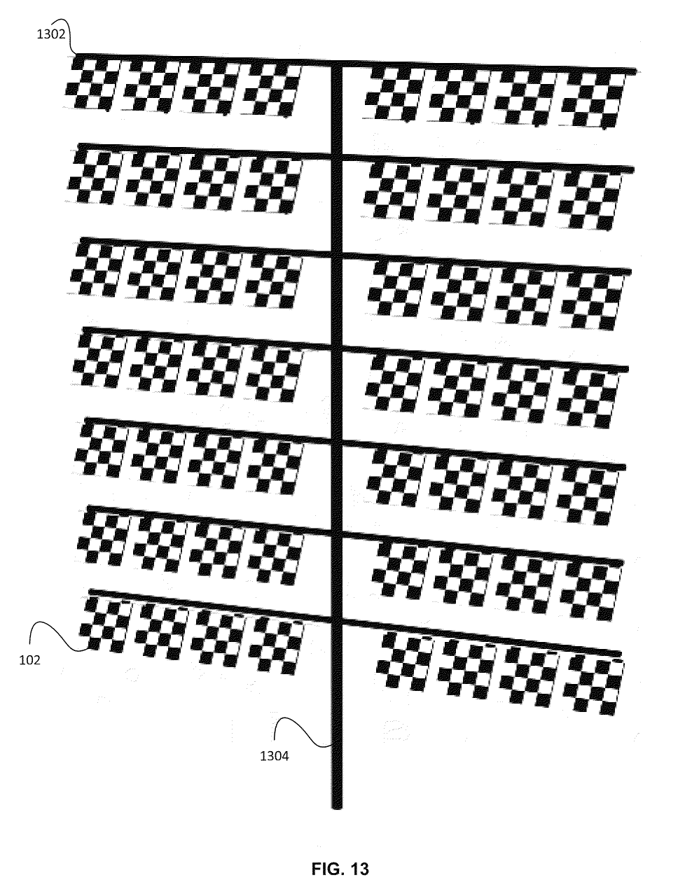

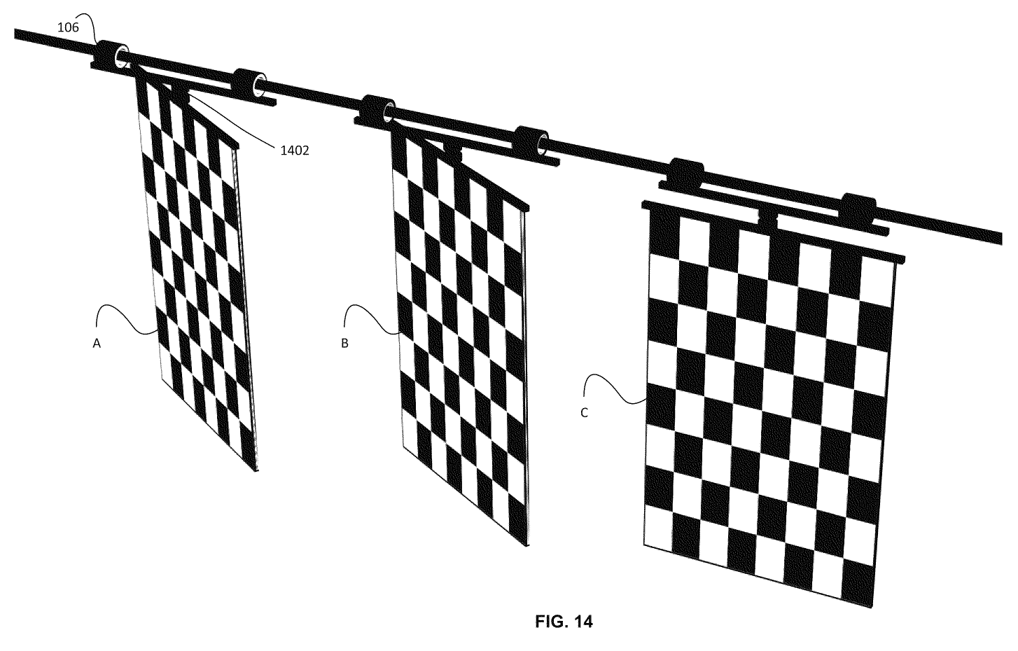

FIG. 13 is a deployment of the assembly 102 using a single vertical pivoting pole 1304 with a plurality of multiple horizontal supports 1302, in accordance with an example embodiment. Because solar panels that are hung from a horizontal support can pivot, the solar panels do not incur as much wind force as those solar panels that are not allowed to pivot in the wind; a relatively lightweight but rigid support can be provided. Thus, FIG. 13 shows a deployment that uses the single vertical pivoting pole 1304 with the plurality of multiple horizontal supports 1302 cantilevering off the single vertical pivoting pole 1304.

FIG. 14 is a deployment of the assembly 104 with a fixed position pivot 1402 interposed between the hinge assembly 106 and the solar panel 102, in accordance with an example embodiment.

As shown, the fixed position pivot 1402 can be interposed between the hinge assembly 106 and the solar panel/backing assembly. Solar panels A and B are pivoted in the left-right direction to better orient them relative to the sun. For clarity, these solar panels do not show any counterweights illustrated in FIG. 5 and FIG. 6 that would change the up-down orientation of the solar panels relative to the sun. However, it will be noted that both orientation methods can be employed at the same time. In some example embodiments, this pivot point is not freely movable and the angle can be set at the time of installation.

Thus, systems and methods for deploying solar panels by suspending them from a horizontal support have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What I claim is:

1. A process for mounting solar panels, the process comprising:
pivotally coupling one or more solar panels to a rigid support, wherein the one or more of solar panels are free to rotate about the rigid support, the rigid support being substantially horizontal to a level supporting surface.

2. The process for mounting solar panels of claim 1, wherein the rigid support is a tension cable.

3. The process for mounting solar panels of claim 2, wherein the tension cable includes an insulated electrical transmission wire.

4. The process for mounting solar panels of claim 1, wherein the one or more solar panels having a backside and front side, further comprising a counterweight rigidly attached to the backside, each counterweight tilting its respective solar panel as to increase exposure of the front side to the sun.

5. The process for mounting solar panels of claim 4, wherein the counterweight comprises a rod having a first end and a second end, wherein the first end is rigidly attached to the backside and the second end is attached to a ball counterbalancing its respective solar panel.

6. The process for mounting solar panels of claim 4, wherein the counterweight is substantially planar, the counterweight being attached at one or more points on the backside of the one or more solar panels.

7. The process for mounting solar panels of claim 6, wherein the counterweight has one or more apertures, the apertures permitting air to pass through the counterweight.

8. The process for mounting solar panels of claim 6, wherein the one or more solar panels are mounted such that the horizontal support bears the weight of one or more rows of the one or more solar panels.

9. The process for mounting solar panels of claim 8, wherein a movement dumping connector connects the one or more solar panels, the movement dumping connector dumping movement of the one or more solar panels.

10. The process for mounting solar panels of claim 8, wherein an array being comprised of one or more rows and columns of the one or more solar panels is further supported by a rigid vertical pole on each end, arranged in a planar formation, substantially at a right angle to a level-supporting surface.

11. The process for mounting solar panels of claim 10, wherein the array is oriented at an obtuse angle to the level supporting surface.

12. The process for mounting solar panels of claim 10, wherein the one or more solar panels are arranged in clothesline-like fashion in such a way as one or more horizontal supports, which support rows of solar panels, are attached at least on each end to one or more rigid T-shaped poles.

13. The process for mounting solar panels of claim 10, wherein the one or more solar panels are arranged on one or more horizontal supports attached to a vertical pole, the vertical pole being attached to the level supporting surface.

14. The process for mounting solar panels of claim 1, wherein the one or more solar panels are mounted on one or more rooftops.

15. The process for mounting solar panels of claim 1, wherein the one or more solar panels are coupled to a rigid horizontal support so that the one or more solar panels are free to rotate about the horizontal support.

16. The process for mounting solar panels of claim 15, wherein the horizontal support bears the weight of one or more rows of the one or more horizontal panels.

17. The process for mounting solar panels of claim 16, further comprising one or more joints attached to the horizontal support as to allow pivoting in additional directions.

18. The process for mounting solar panels of claim 16, further comprising one or more movement dumping connectors attached to the horizontal support to allow movement of the solar panels in additional directions.

19. The process for mounting solar panels of 16, further comprising one or more hinges attached to the horizontal support as to allow movement of the solar panels in additional directions.

20. The process for mounting solar panels of claim 19, further comprising a hinge attached above each joint to the horizontal support.
